(19) United States
(12) Patent Application Publication
(10) Pub. No.: US 2021/0224880 A1
(43) Pub. Date: Jul. 22, 2021

(54) ESSENTIAL NEEDS TRACKING AND EMERGENCY PREPAREDNESS APPLICATION

(71) Applicant: Mastercard International Incorporated, Purchase, NY (US)

(72) Inventors: Christopher T. Scholl, Florissant, MO (US); Marthom Daetz, O'Fallon, MO (US)

(73) Assignee: Mastercard International Incorporated, Purchase, NY (US)

(21) Appl. No.: 16/744,322

(22) Filed: Jan. 16, 2020

(51) Int. Cl. G06Q 30/06; G06K 7/14

(52) U.S. Cl. CPC G06Q 30/0633; G06K 7/1417; G06K 7/1413

(57) ABSTRACT

An item tracker computing device includes a processor coupled in communication with a memory. The processor is programmed to receive transaction data from a payment network. The transaction data is associated with a user. In addition, the processor is programmed to receive assistance items data from a service provider. The processor is also programmed to process the transaction data and the assistance items data to generate essential needs data for the user. Moreover, the processor is programmed to store the essential needs data in a user profile and, based upon a location of the user corresponding with a location of a catastrophic event, transmit the user profile to the service provider.

### FIELD OF THE DISCLOSURE

This disclosure relates to tracking a user's essential needs items and, more specifically, to an item tracker with alert, notification, and reporting functionality.

### BACKGROUND OF THE DISCLOSURE

Catastrophic events, such as natural disasters, are often unpredictable. There may be little warning as to when and where such an event may take place. In addition, many disasters are unavoidable. Even with advanced notice, some disasters will have a significant impact on the lives of those person affected by the event. Finding emergency assistance by those affected can be critical to surviving and recovering from a disaster. Furthermore, after identifying organization and/or government agencies which are intended to provide emergency relief, it may be difficult for affected persons to acquire those items that are essential for their needs, such as medications, special dietary items, correct clothing sizes, etc. Even in situation where an affected person and/or family has planned for such as disaster and may have records of these essential items, transmitting such information to emergency relief organizations can be difficult.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, an item tracker computing device is provided. The item tracker computing device includes a processor coupled in communication with a memory. The processor is programmed to receive transaction data from a payment network. The transaction data is associated with a user. The processor is also programmed to receive assistance items data from a service provider. Furthermore, the processor is programmed to process the transaction data and the assistance items data to generate essential needs data for the user and to store the essential needs data in a user profile. Moreover, the processor is programmed to, based upon a location of the user corresponding with a location of a catastrophic event, transmit the user profile to the service provider.

In another aspect, a computer-implemented method for tracking essential needs items of a user and advising a service provider about the essential needs items during a disaster relief effort is provided. The method is performed using an item tracker computing device that includes a processor coupled in communication with a memory. The method includes receiving transaction data from a payment network. The transaction data is associated with the user. The method also includes receiving assistance items data from the service provider. In addition, the method includes processing the transaction data and the assistance items data to generate essential needs data for the user and then storing the essential needs data in a user profile. Furthermore, the method includes, based upon a location of the user corresponding with a location of a catastrophic event, transmitting the user profile to the service provider.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an Essential Needs—Emergency Support (ENES) tracking system including an item tracker computing device, in accordance with one embodiment of the present disclosure;

FIG. 2 is a schematic diagram illustrating an example multi-party payment card system coupled in communication with the ENES system shown in FIG. 1;

FIG. 3 is an example configuration of a client computing device operated by a user, such as a cardholder shown in FIG. 2;

FIG. 4 is an example configuration of a server system, such as the item tracker shown in FIG. 1;

FIG. 5 is a component view of the item tracker shown in FIG. 1;

FIG. 6 is an example screenshot of an ENES application showing a “Profile Details” screen provided by the item tracker shown in FIG. 1;

FIG. 7 is an example screenshot of the ENES application shown in FIG. 6, showing an “Essential Food Items” screen;

FIG. 8 is an example screenshot of the ENES application shown in FIG. 6, showing a “Clothing Sizes” screen;

FIG. 9 is an example screenshot of the ENES application shown in FIG. 6, showing a “Medical Information” screen;

FIG. 10 is an example screenshot of the ENES application shown in FIG. 6, showing an “Emergency Details” screen;

FIG. 11 is an example screenshot of the ENES application shown in FIG. 6, showing a “Pick Up Items” screen; and

FIG. 12 is a flowchart illustrating an exemplary computer-implemented method for tracking a user's essential needs items and advising an emergency relief organization about the user's items during a disaster relief effort, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. It is contemplated that the invention has general application for tracking a consumer's purchases and determining essential need items, which are transmitted to disaster relief organizations should the consumer be affected by a catastrophic event. The scope of the present invention is defined only by the appended claims, along with the full scope of equivalents to which such claims are entitled.

As used herein, the term “catastrophic event” includes natural and man-made catastrophes. Such natural and man-made catastrophic events may include, for example, hurricanes, tornadoes, earthquakes, meteorite showers, military action, riots, explosions, and auto and aviation accidents, and the like.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

As used herein, the terms “transaction card,” “financial transaction card,” and “payment card” may include any suitable transaction card, such as a credit card, a debit card, a charge card, a membership card, a promotional card, an identification card, a prepaid card, a gift card, and/or any other device that may hold payment account information, such as a mobile phone, smart phone, personal digital assistant (PDA), key fobs, and/or computer. Each type of transaction card can be used as a method of payment for performing a transaction.

Furthermore, as used herein, the term “real-time” includes at least one of the times of occurrence of the associated events, the time of collection of data, the time to process the data, and the time of a system response to the events and the environment. For the activities and the events in the embodiments described herein as occurring in real-time, it should be assumed that they occur substantially instantaneously.

The Essential Needs—Emergency Support (ENES) system described herein is configured to track a user's essential needs data and advise an emergency relief organization about the user's items during a catastrophic event or disaster relief effort. In particular, the ENES system is configured to track and/or collect a user's food-, clothing-, and medicinal-related purchases to facilitate generating an essential needs item list (i.e., essential needs data). The ENES system includes an essential needs—emergency support computing device (item tracker) coupled in communication with a transaction processor that is configured to process payment transactions and/or a database that is configured to store data related to the transactions (i.e., transaction data). The transactions are associated with purchases made by cardholders using payment cards and are processed over a payment network that includes the transaction processor and/or the database. The item tracker is configured to receive line item data used to identify a user's food-, clothing-, and medicinal-related purchases from, for example, the transaction processor, the database, etc.

The item tracker includes a processor coupled in communication with a memory. The item tracker is further coupled in communication with a database for storing information, such as, for example, transaction data associated with food-, clothing-, and medicinal-related purchase transactions initiated by the user and/or by other cardholders, and registration data (name, address, etc.) related to the user and/or his or her household members. Moreover, the item tracker is coupled in communication with one or more user computing devices (e.g., a smart phone, laptop, desktop, tablet, etc.).

The item tracker is configured to receive line item data used to identify a user's food-, clothing-, and medicinal-related purchases from, for example, the transaction processor, the database, etc. The line item data received by the item tracker corresponds to the user's transaction data (e.g., receipt details). More specifically, each line item of the line item data corresponds to a specific product purchased by the user, as indicated by the user's transaction data.

In the example embodiment, the user may be required to manually set up a user profile using a user computing device, wherein “manually set up” includes filling in a number of fields with information associated with the user. In one embodiment, at least some of the user profile information may be imported from another source, such as from a health record of the user, for example, available from the user's healthcare or health insurance provider and/or from a user profile associated with another application (e.g., a fitness application, a social media application, a transaction processor, etc.). It should be noted that the user can setup additional profiles under their profile that are associated with additional family and/or household members. This enables the item tracker to collect essential needs data for an entire household rather than just an individual.

At least some of the user's essential needs data and/or registration data contained in the user profile may be input directly or manually by the user, and at least some of the data in the user profile may be automatically tracked, stored, updated, edited, or accessed by the user computing device(s) and/or the transaction processor. For example, a user may: (i) input essential needs information related to clothing sizes (e.g., waist diameter, inseam length, shoe size, etc.); (ii) input medication prescription information and/or track the user's prescription data electronically (e.g., accessing their healthcare provider's and/or pharmacy's computing systems); and (iii) track food items by scanning barcodes of items purchased or deemed essential by the user. The item tracker is configured to enable access to the user's profile, for example, from a plurality of user computing device(s) and/or the transaction processor, to make tracking and monitoring the user's essential needs data more efficient and less burdensome for the user.

As described herein, the item tracker may receive line item data from a number of sources, including for example, a credit or debit card financial transaction message on a payment network. The financial transaction message can include product-specific-data, such as stock keeping unit (SKU) data. In addition, the item tracker may receive line item data from payment gateways or transaction processors through which the payment may be routed. The payment gateways or transaction processors may have an alternative product/goods identifier other than SKU data. Moreover, the item tracker can receive line item data from one of the user computing devices, such as by QR/barcode scanning, when the user is shopping at an online merchant site using a digital wallet (e.g., a Masterpass™ enabled site), or from a list of items contained in a virtual shopping cart. In some embodiments, the item tracker may be able to identify the purchased food, clothing, and/or medications by statistical analysis of the purchase amounts.

The item tracker is also coupled in communication with one or more third party services/external databases, which are configured to receive the user's profile information and/or line item data, for example, manually and/or automatically via one or more application programming interfaces (APIs). The third party services can include, for example, and without limitation, emergency relief organization, food banks, clothing banks, temporary shelters, government agencies, charities, and the like. The third party services/external databases may be configured to receive a user's profile data to automatically register the user with the respective service. In addition, the third party services/external databases may be configured to receive the line item data to facilitate “automatic” provisioning of a personalized sustainability package to the user to help the user during their time of need.

In the example embodiment, a user opts in to use the item tracker service, for example, with one or more payment cards and/or a digital wallet service (e.g., a Masterpass account). The user may choose to input the user's essential needs information, such as clothing sizes, known medical conditions, allergies, and/or medication prescriptions, into a user profile. In some embodiments, the item tracker may be able to pre-populate portions of the user's essential needs data using the line item data for the user's historical purchase data, if available. In addition, in some embodiments, the item tracker may provide an option for the user to input their doctor contact information and/or their medical insurance provider information. It is noted that inputting essential needs information is not required for the item tracker to generate the user's essential needs data. Rather, the user's essential needs information can be used to provide more precise essential needs data to the third party services.

The item tracker, as described herein, is configured to analyze the user's historical transactions to identify foods, clothing, and medicines purchased by the user. The purchases of specific products can be associated with a purchase frequency (i.e., they may be recurring). The item tracker identifies such frequently (e.g., recurring) purchased items and adds them to a “recurring items list.” In some embodiments, the items on the recurring items list are compared to or cross-referenced with a list of items that are identified as “need to survive items.” The need to survive items list can be received from one or more of the third party external databases and/or generated by a list of items that are available from the third party services. For example, in some embodiments, one third party service may provide a list of items that it deems as need to survive items, of which it then solicits donations for such items to assist its emergency relief efforts. Another third party (such as a clothing bank), however, may provide a list of items that it has available for emergency assistance. The item tracker cross-references the recurring items with the needs to survive list. Matching items may then be added to the user's essential needs data. In this manner, recurring but not essential purchases (e.g., purchases of alcohol) are not added to the user's essential needs data. This same process applies to items that may be manually input by the user.

In some embodiments, the item tracker may analyze the user's recent purchases to determine food, beverage, clothing, and/or medicine to add to the user's essential needs data. The user can review the essential needs data and remove any items that the user considers non-essential. For example, in some embodiments, the line item data tracked by the item tracker may include clothing size information. The size information may change dues to a user losing weight, gaining weight, growing older, etc. The user can review the essential needs data associated with clothing sizes and adjust it as necessary. The item tracker maintains this information to facilitate improving the user's essential needs data.

In one embodiment, the user may be able to send their essential needs data seamlessly to one or more of the third party services. The third party services may choose to opt-in to the item tracker service to receive immediate access to a user's essential needs data. This facilitates the third party service attaining a better understanding of a user's essential needs.

The item tracker is further in communication with at least one merchant computing device. The merchant computing device may include a point-of-sale (POS) device or terminal at a merchant location (e.g., a brick-and-mortar merchant location) and/or may include a virtual merchant POS (e.g., for a merchant with online purchase functionality). In the example embodiment, each merchant computing device is associated with a merchant, such as a grocery store, clothing store, pharmacy, or other vendor having food-, clothing-, and medicinal-related goods and/or services available for purchase.

The item tracker is configured to communicate with the merchant computing device(s) to receive line item data concerning the goods to be purchased. For example, integrated merchants will send line item data to the item tracker, for example, when the user selects the option to pay. The item tracker analyzes the items and determines whether to add any of the items to the user's essential needs data. For example, the item tracker may be able to provide a list of potentially essential items to the user through the merchant computing device. In the example embodiment, the merchants do not receive the user's essential needs data. Rather, through integration with Masterpass, for example, the merchant will pass the item's line item data to the item tracker and the item tracker will be responsible for managing the essential needs data.

In the example embodiment, the item tracker is configured to access or communicate with the one or more merchant computing devices through a cloud-based API, which functions as a middleware layer and facilitates transmission of transaction data from a merchant computing device to the payment network. The API further enables any number of merchant computing devices to communicate with the item tracker and, accordingly, with the user through the user computing device and an e-commerce application. Additionally, the API enables the user to access and interact with certain features of the merchant computing device(s) through the e-commerce application, including making mobile payments directly to a merchant POS device. In one embodiment, the user may only be permitted to use the e-commerce application to make payments to a merchant POS device when the user is in a specific proximity to the merchant POS device (e.g., the user is in a grocery store and may purchase their groceries through the e-commerce application). In other embodiments, the user may be permitted to initiate transaction with the merchant POS device from any location (e.g., the user is making a payment for delivery from a merchant through the e-commerce application at a location remote from the merchant's location).

In one embodiment, the item tracker is in communication with at least one of (i) a transaction processor that is configured to process payment transactions, and/or (ii) a database that stores the transaction data. As described above, in the example embodiment, the transaction processor and the database are part of a payment processing network that is configured to process payment transactions, such as for credit and debit cards. Transaction data includes such elements as a transaction amount, a merchant identifier, and a description of the purchase made (e.g., a particular item or product). In some embodiments, transaction data may further include additional elements such as a location identifier, which may identify where the transaction was initiated (i.e., a location of the consumer), and/or the location of the merchant. The item tracker receives transaction data associated with purchases of food-, clothing-, and medicinal-related items, made by the user using their payment card and/or digital wallet. The item tracker may associate and/or index the transaction data with the user profile for the user, such that the transaction data for the user is only stored and/or processed in conjunction with that user's profile. The item tracker stores and/or processes the transaction data to determine which items were purchased, from which merchants the items were purchased, and/or which brands of items were purchased. Accordingly, the item tracker develops a usage history associated with the user profile such that the item tracker may determine a user's essential needs items, which can be used during an emergency or in a time of need.

The item tracker is further in communication with a computing device associated with a third party service provider, which provides an emergency relief service to the user. For example, the third party service provider may be an emergency relief organization, a food bank, a clothing bank, a government agency, a charity, and the like. The item tracker may send essential needs data to the third party service provider that includes the user's registration data and other data from the user's profile. The third party service provider may provide a personalized sustainability package to the user based on the essential needs data. For example, a food bank may provide the user with essential food items listed in the user's essential needs data, whereas a clothing bank may provide the user with clothing based on personal information contained in the essential needs data.

The technical effects of the systems and methods described herein are achieved by performing at least one of the following steps: (i) receiving transaction data from a payment network; (ii) receiving assistance items data from a service provider; (iii) processing the transaction data and the assistance items data to generate essential needs data; (iv) storing the essential needs data in a user profile; and (v) transmitting the user profile to the service provider.

### Essential Needs Tracking System

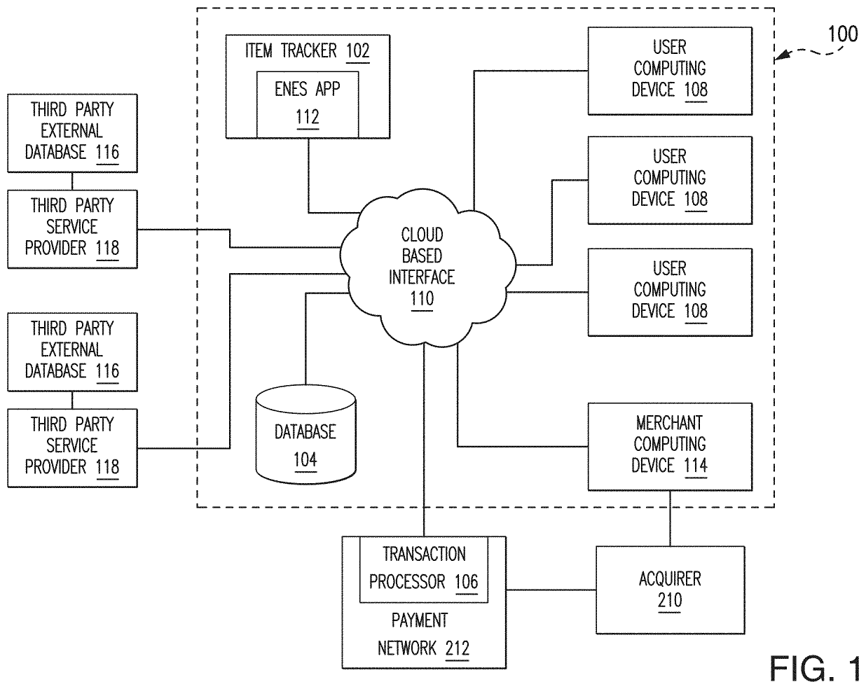

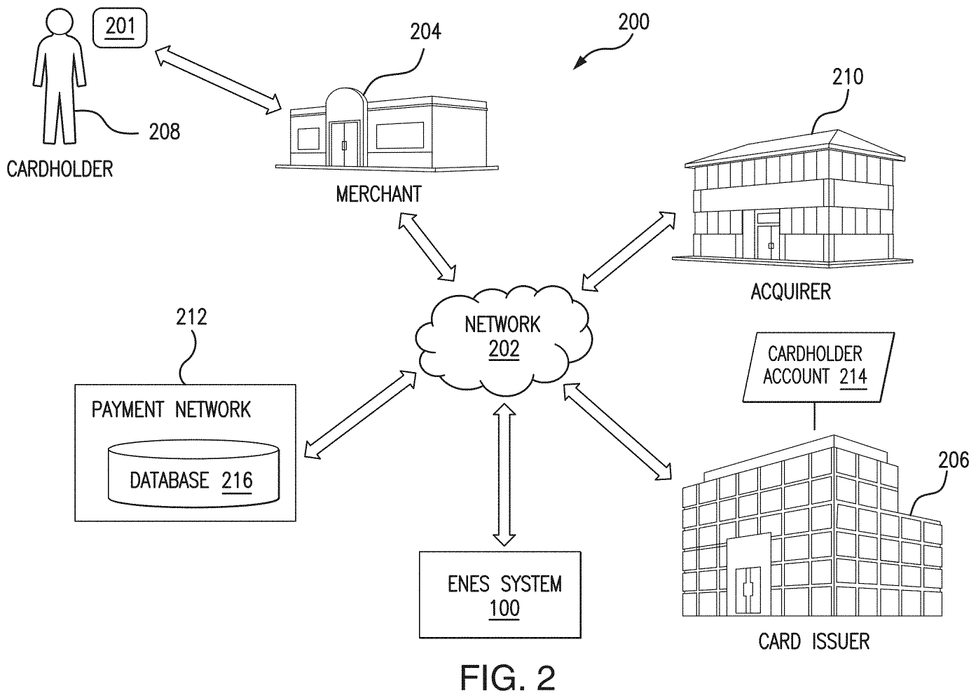

FIG. 1 is a block diagram of an Essential Needs—Emergency Support (ENES) tracking system 100 including an item tracker computing device (item tracker) 102. The item tracker 102 includes at least one processor (not shown) coupled in communication with a database 104. The database 104 contains information on a variety of matters, including stored transaction data for one or more users, line item data used to identify one or more user's food-, clothing-, and medicinal-related purchases, one or more user profiles, and other information described herein. The database 104 may be stored on item tracker 102 or may be stored remotely from item tracker 102, in which the database 104 may be non-centralized. In the example embodiment, the ENES system 100 is coupled in communication with a transaction processor 106, which is integral to and/or associated with a payment network 212. The payment network 212 is described more fully herein with respect to FIG. 2.

In the example embodiment, the ENES system 100 further includes a plurality of client subsystems, also referred to as client systems or user computing devices 108. In one embodiment, user computing devices 108 are computers including a web browser, such that item tracker 102 is accessible to user computing devices 108 using a cloud-based interface 110, such as the Internet. The user computing devices 108 are interconnected to the cloud-based interface 110 via, for example, a network, such as a local area network (LAN) and/or a wide area network (WAN), a dial-in connection, a cable modem, a wireless-connection, and/or a special high-speed ISDN line. The user computing devices 108 may be any device capable of interconnecting to the cloud-based interface 110 including a mobile computing device, such as a laptop or desktop computer, a web-based phone (e.g., a “smart phone”), a personal digital assistant (PDA), a tablet or phablet, a web-connectable appliance, a “smart watch” or other wearable device, or other web-connectable equipment. Although three (3) user computing devices 108 are shown in FIG. 1, it is understood that the ENES system 100 can include fewer or more user computing devices 108.

The item tracker 102 is configured to communicate with a user computing device 108 associated with a user (not shown in FIG. 1). The user computing device 108 is configured to execute for display an Essential Needs—Emergency Support application (ENES App) 112. In some embodiments, the ENES App 112 may be stored in the cloud-based interface 110, which may include cloud storage capability as well as any cloud-based API that facilitates communication between a merchant computing device 114 and the item tracker 102 and/or between the user computing devices 108 and the item tracker 102. The ENES App 112 stores a user profile associated with the user, for example, in the database 104. The user profile includes registration data for the user. Additionally, the user profile may be viewed, accessed, and/or updated by the user computing devices 108. The user accesses the ENES App 112 to communicate with the item tracker 102, in particular, to input personal information and/or update the user's essential need items.

The ENES system 100 further includes the merchant computing device 114, which may include a real or virtual point-of-sale (POS) device, an inventory computing device, or any other computing device capable of communicating with the transaction processor 106 and/or with the item tracker 102. In the example embodiment, merchant computing device 114 is associated with a merchant (not shown). The item tracker 102 is configured to access the merchant computing device 114 through, for example, the cloud-based interface 110. The item tracker 102 is configured to communicate with the merchant computing device 114 to access data (e.g., line item data, SKU information, etc.) and/or to access any virtual merchant capabilities of the merchant (e.g., to order delivery of an item from the merchant). Additionally or alternatively, at least one of the user computing devices 108 may access the merchant computing device 114 directly, using for example, an e-commerce application (not shown) as an interface, to access the virtual merchant capabilities of the merchant. Although only one merchant computing device 114 is shown in FIG. 1, it is understood that the item tracker 102 may be coupled in communication with any number of merchant computing devices 114.

In the example embodiment, item tracker 102 receives the user's historical transaction data from, for example, the payment network 212. To identify the foods, clothes, and medicines purchased by the user, the item tracker 102 receives line item data from the merchant computing device 114 and/or the payment network 212. In the example embodiment, the item tracker 102 determines the user's essential need items based on the user's historical food, clothing, and medicine purchases.

The item tracker 102 accesses one or more third party external databases 116 to retrieve, for example, a need to survive items list and/or a list of items that are available from a third party service provider 118. In addition, the item tracker 102 may access the database 104 to retrieve the user profile for the user. The user profile may include the user's registration data. In some embodiments, the item tracker 102 receives real-time purchase data related to items the user is purchasing. For example, integrated merchants will send line item data to the item tracker 102, for example, when the user selects the option to pay. The item tracker 102 analyzes the items and determines whether to add any of the items to the user's essential needs data. In one embodiment, the item tracker 102 will be able to provide a list of potentially essential items to the user through the merchant computing device 114 and/or the user computing device 108. The item tracker 102 leverages the user's registration data, essential needs data, their purchase history data, and the food, clothing, and/or medicine purchases to determine a user's essential needs items, which can be used during a catastrophic event, emergency, or in a time of need. The item tracker 102 generates a list of potentially essential items and returns the list to the user computing device 108 for display to the user within the ENES App 112 and/or the e-commerce application.

The item tracker 102 is further in communication with at least one service provider 118. The service provider 118 represents any entity configured to provide emergency and/or disaster relief services to the user, such as emergency relief organizations, food banks, clothing banks, temporary shelters, government agencies, charities, and the like. The item tracker 102 sends essential needs data to the service provider 118 that includes the user's personal data and other data from the user's profile. The service provider 118 may provide a personalized sustainability package to the user based on the essential needs data. For example, a food bank may provide the user with essential food items listed in the user's essential needs data, whereas a clothing bank may provide the user with clothing based on personal information contained in the essential needs data.

### Payment Network Systems

FIG. 2 is a schematic diagram illustrating an example multi-party payment card system 200 coupled in communication with the ENES system 100. The ENES system 100 may be in communication with one or more elements of payment card system 200, such as, for example, a merchant bank or acquirer 210 and the payment network 212. The payment card system 200 enables payment-by-card transactions for food-, clothing-, and medicinal-related purchases. The present disclosure relates to a payment card system, such as a credit card payment system using the Mastercard® payment card system payment network 212 (also referred to as an “interchange” or “interchange network”). The Mastercard® payment card system payment network 212 is a proprietary communications standard promulgated by Mastercard International Incorporated® for the exchange of financial transaction data between financial institutions that are customers of Mastercard. (Mastercard is a registered trademark of Mastercard International Incorporated located in Purchase, N.Y.)

In the payment card system 200, a financial institution such as a card issuer 206 issues a payment account card 201, such as a credit card account or a debit card account, to a cardholder 208. The cardholder 208 uses the payment account card 201 to tender payment for a purchase from a merchant 204. To accept payment with the payment account card, the merchant 204 must normally establish an account with a financial institution that is part of the payment card system 200. This financial institution is usually called the “merchant bank,” the “acquiring bank,” the “acquirer bank,” or simply the “acquirer.”

When the cardholder 208 tenders payment for a purchase with the payment account card 201, the merchant 204 requests authorization from the acquirer 210 for the amount of the purchase. The request may be performed over the telephone, but is usually performed through the use of a point-of-sale (POS) terminal, which may read the cardholder's account information from the magnetic stripe or EMV chip of the payment account card 201, or may accept the cardholder's account information electronically, and communicates electronically with the transaction processing computers of the acquirer 210. Alternatively, the acquirer 210 may authorize a third party to perform transaction processing on its behalf. In this case, the POS terminal will be configured to communicate with the third party. Such a third party is usually called a “merchant processor” or an “acquiring processor.” In some instances, a merchant (e.g., the merchant 204) stores payment card information associated with a cardholder (e.g., the cardholder 208) and requests authorization from the acquirer 210 using the stored payment card information, rather than reading the cardholder's account information from the payment account card 201 itself (i.e., a card-on-file (COF) transaction).

Using the payment network 212 (e.g., using a transaction processor such as the transaction processor 106 (shown in FIG. 1)), the computers of the acquirer 210 or the merchant processor will communicate with the computers of the card issuer 206, for example, via a network 202, to determine whether the cardholder's account 214 is in good standing and whether the purchase is covered by the cardholder's available credit line or account balance. Based on these determinations, the request for authorization will be declined or accepted. If the request is accepted, an authorization code is issued to the merchant 204.

When a request for authorization is accepted, the available credit line or available balance of the cardholder account 214 is decreased. Normally, a charge is not posted immediately to the cardholder account 214 because bankcard associations, such as Mastercard, have promulgated rules that do not allow the merchant 204 to charge, or “capture,” a transaction until the goods are shipped or the services are delivered. When the merchant 204 ships or delivers the goods or services, the merchant 204 captures the transaction by, for example, appropriate data entry procedures on the POS terminal. If the cardholder 208 cancels a transaction before it is captured, a “void” is generated. If the cardholder 208 returns goods after the transaction has been captured, a “credit” is generated.

For PIN debit card transactions, when a request for authorization is approved by the card issuer 206, the cardholder account 214 is decreased. Normally, a charge is posted immediately to the cardholder account 214. The bankcard association then transmits the approval to the acquiring processor for distribution of the goods/services, or cash in the case of an ATM transaction.

After the transaction is captured, the transaction is cleared and settled between the merchant 204, the acquirer 210, and the card issuer 206. Clearing refers to the communication of financial data for reconciliation purposes between the parties. Settlement refers to the transfer of funds between the merchant's account, the acquirer 210, and the card issuer 206 associated with the transaction.

Transaction data associated with the transaction is processed by the transaction processor 106 and/or is stored in a transaction database 216. More specifically, for transactions associated with food-, clothing-, and medicinal-related purchases, as described herein, the transaction data may include such elements as a transaction amount, a merchant identifier, SKU data or other line item data, such as a description of the purchase made (e.g., a particular item or product). In some embodiments, the transaction data may further include additional elements such as a location identifier, which may identify where the transaction was initiated (i.e., a location of the cardholder 208), and/or the location of the merchant 204. The transaction data is communicated between the transaction processor 106 and the item tracker 102 (shown in FIG. 1).

### Exemplary Computer Systems

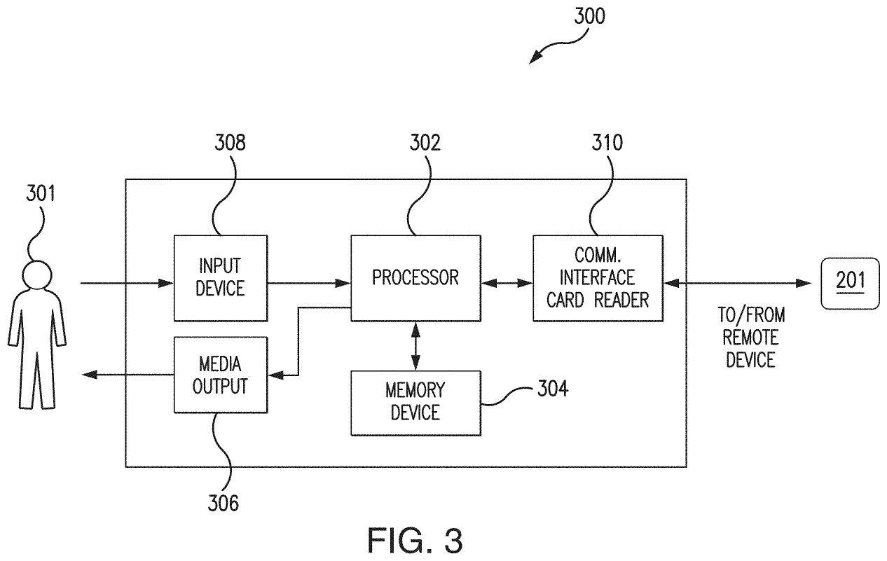

FIG. 3 is an example configuration of a client computing device 300 operated by a user 301, such as the cardholder 208 (shown in FIG. 2). The client computing device 300 includes, but is not limited to, the user computing devices 108 (client systems) and/or the merchant computing devices 112 (both shown in FIG. 1). In the example embodiment, the client computing device 300 includes a processor 302 for executing instructions. In some embodiments, executable instructions are stored in a memory device 304. The processor 302 includes one or more processing units, for example, a multi-core processor configuration. The memory device 304 is any device allowing information such as executable instructions and/or written works to be stored and retrieved. The memory device 304 includes one or more computer readable media.

In the example embodiment, the processor 302 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the client computing device 300 may be widely deployed, it may be impractical to manually update software for each client computing device 300. Therefore, the system 100 may, in some embodiments, provide a mechanism for automatically updating the software on the client computing device 300. For example, an updating mechanism may be used to automatically update any number of components and their drivers, both network and non-network components, including system level (OS) software components. In some embodiments, the client computing device 300 components are dynamically loadable and unloadable; thus, they may be replaced in operation without having to reboot the OS.

The client computing device 300 also includes at least one media output component 306 for presenting information to the user 301. The media output component 306 is any component capable of conveying information to the user 301. In some embodiments, the media output component 306 includes an output adapter such as a video adapter and/or an audio adapter. An output adapter is operatively coupled to the processor 302 and operatively connectable to an output device such as a display device, for example, and without limitation, a liquid crystal display (LCD), organic light emitting diode (OLED) display, or “electronic ink” display, or an audio output device such as a speaker or headphones.

In some embodiments, the client computing device 300 includes an input device 308 for receiving input from the user 301. The input device 308 may include, for example, one or more of a touch sensitive panel, a touch pad, a touch screen, a stylus, a position detector, a keyboard, a pointing device, a mouse, and an audio input device. A single component such as a touch screen may function as both an output device of the media output component 306 and the input device 308.

The client computing device 300 may also include a communication interface 310, which is communicatively connectable to a remote device such as the item tracker 102 or a web server operated by a merchant (e.g., the merchant computing device 114, both shown in FIG. 1). The communication interface 310 may include, for example, a wired or wireless network adapter or a wireless data transceiver for use with Bluetooth communication, radio frequency (RF) communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 306 and, optionally, receiving and processing input from the input device 308. A user interface may include, among other possibilities, a web browser and a client application. Web browsers enable users, such as the user 301, to display and interact with media and other information typically embedded on a web page or a website from a web server associated with a merchant. A client application allows the user 301 to interact with a server application associated with, for example, a merchant and/or the ENES system 100 (shown in FIG. 1).

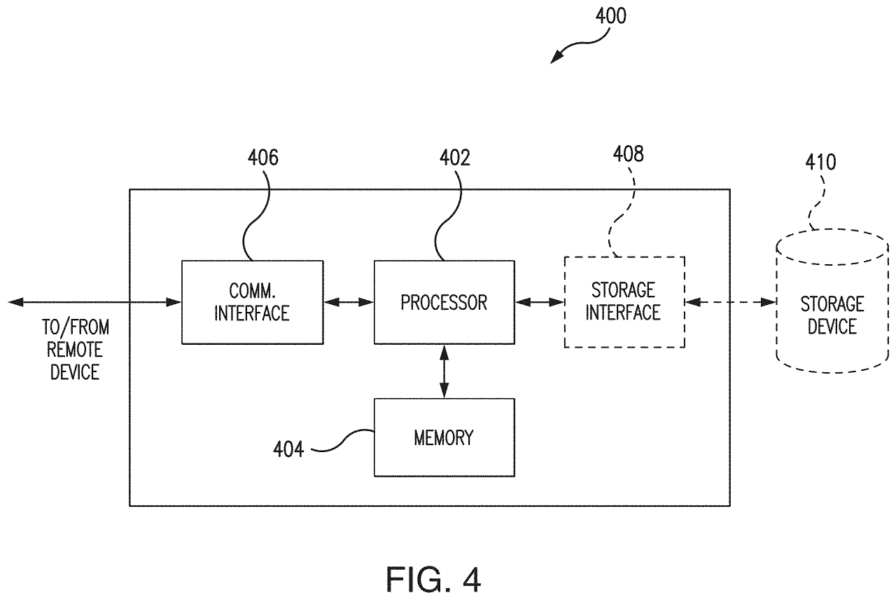

FIG. 4 is an example configuration of a server system 400. The server system 400 includes, but is not limited to, the item tracker 102, the transaction processor 106, the merchant computing device 114. The service provider 118, and/or the third-party external databases 116 (all shown in FIG. 1). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). In the example embodiment, the processor 402 may be implemented as one or more cryptographic processors, as described above with respect to the user system 400.

The processor 402 is operatively coupled to a communication interface 406 such that the server system 400 can communicate with a remote device such as a client computing device 300 (shown in FIG. 3) or another server system 400. For example, the communication interface 406 may receive communications from user computing devices 108 via the Internet, as illustrated in FIG. 1.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the transaction database 216 (shown in FIG. 2). For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404, the memory device 304, and the storage device 410 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

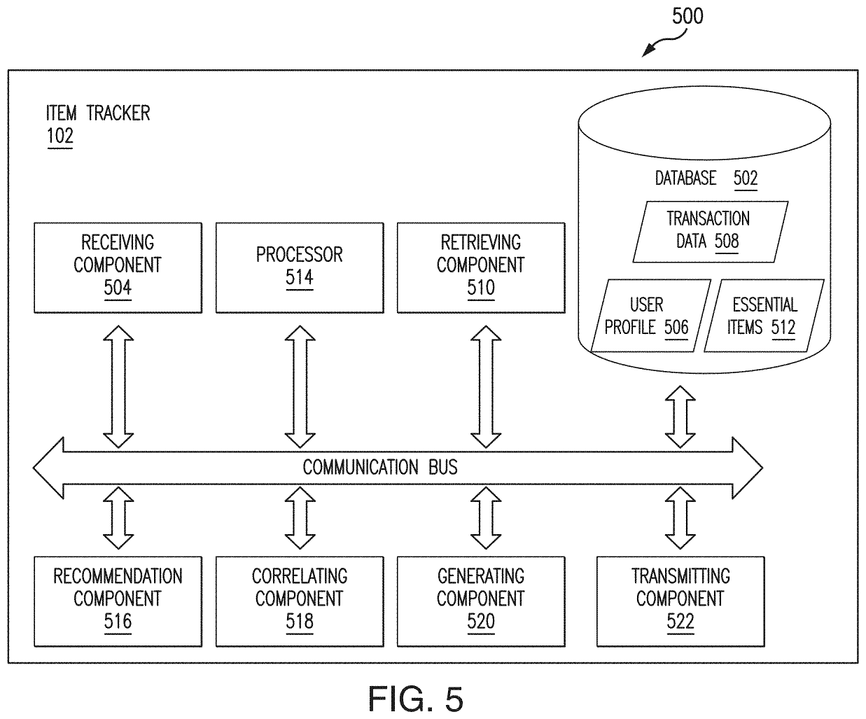

FIG. 5 is a component view 500 of the item tracker 102 that may be used in the ENES system 100 (shown in FIG. 1). In the example embodiment, the item tracker 102 includes a database 502. The database 502 may be coupled to several separate components within the item tracker 102, which are configured to perform specific tasks, as discussed herein.

In the example embodiment, the item tracker 102 includes a receiving component 504. The receiving component 504 is configured to receive registration data from a user computing device (e.g., the user computing device 108 (shown in FIG. 1)). The registration data may be stored in the database 502 in a user profile 506 of the user associated with the user computing device 108. The receiving component 504 is further configured to receive transaction data 508 from a payment network, such as the payment network 212 (shown in FIG. 2), and/or the merchant computing device 114, wherein the transaction data 508 includes, for example, line item data (e.g., SKU data), total transaction amounts, time of the transactions, and/or a location of the transactions. The item tracker 102 uses the location identifier to locate the user computing device 108, for example, at a merchant location or at home. The location identifier can also be used to determine a general location of the cardholder, such as the cardholder 208 (shown in FIG. 2), if the cardholder 208 did not include location data in his or her registration information. As described herein, the cardholder location can be used to notify the cardholder of nearby service providers in the event of a catastrophic event, disaster, or other emergency.

The item tracker 102 further includes a retrieving component 510, which is configured to retrieve historical transaction data 508 from the transaction database 216 and/or available essential items data 512 from, for example, the third party external databases 116 (shown in FIG. 1). The item tracker 102 further includes a processor 514 in communication with a recommendation component 516, a correlating component 518, and a generating component 520. The processor 514 processes the available user profile data 506 (e.g., user registration information), the transaction data 508, and the available essential items data 512, to generate the cardholder's essential needs item list (i.e., the essential needs data), which can be transmitted to the service providers 118 during a catastrophic event, an emergency, or in a time of need.

### Exemplary Screenshots of a Software Application

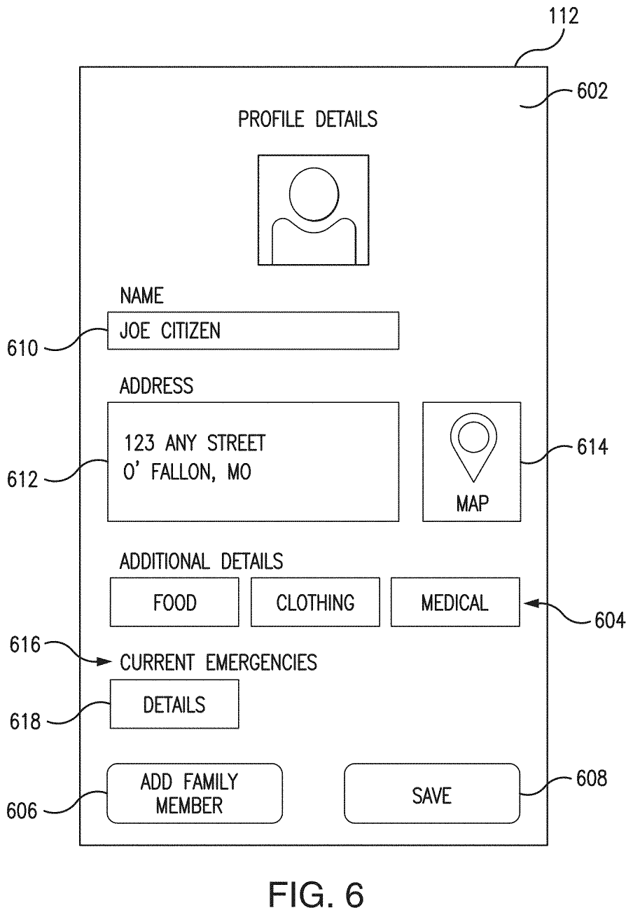

FIG. 6 is an example screenshot of the ENES App 112 showing a “Profile Details” screen 602 provided by the item tracker 102 (shown in FIG. 1). The ENES App 112 is displayed on a user interface of a user computing device 108 (shown in FIG. 1). In the exemplary embodiment, the ENES App 112 provides a plurality of icons 604 for a user (e.g., the user 301, shown in FIG. 3) to interact with to view additional screens of the ENES App 112. The plurality of icons 604 include a “Food” icon, a “Clothing” icon, and a “Medical” icon. Although three (3) icons 604 are illustrated, it should be understood that there may be any number of icons 604 in various alternate embodiments of the ENES App 112. The ENES App 112 also includes an “Add Family Member” icon 606 and a “Save” icon 608 at the bottom of the Profile Details screen 602.

On the Profile Details screen 602, the user 301 can add his or her registration information, such as his or her name to a “Name” line 610 by pressing or tapping in the provided box and entering their name using, for example, the input device 308 (shown in FIG. 3) of the computing device 108. In addition, the user 301 can add his or her address to an “Address” section 612 in substantially the same manner as their name. Alternatively, if the user 301 chooses, he or she can press a “Map” icon 614 to place a map marker indicating their address.

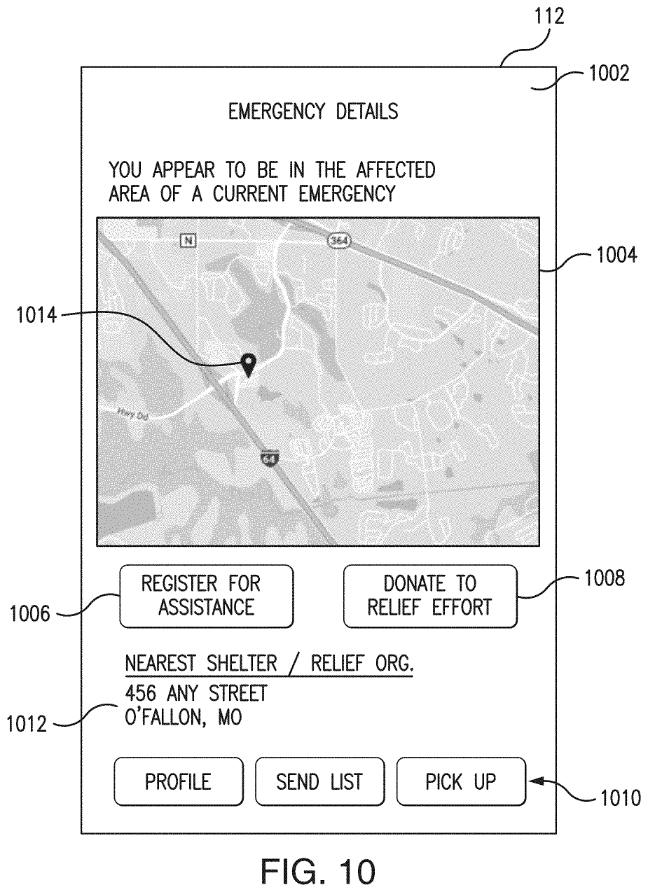

The Profile Details screen 602 also includes a “Current Emergencies” section 616 that includes a Details icon 618. As described herein, the item tracker 102, for example, via the ENES App 112 displayed on the user computing device 108, may use the geo-location of the user computing device 108 to determine whether the user is located in a designated disaster area or an area experiencing a catastrophic event requiring relief efforts. The user can select the Details icon 618 to display an “Emergency Details” screen 1002 (shown in FIG. 10) if there is a current emergency or catastrophic event. In some embodiments, if there is not a current emergency or catastrophic event affecting the user as designated by, for example, the user's address in the Address section 612 or a geo-location of the user computing device 108, the Details icon 618 may be “greyed out” and not selectable. In certain embodiments, if there is a current emergency or catastrophic event affecting the user, the Details icon 618 may flash and/or alternate colors to facilitate capturing the user's attention.

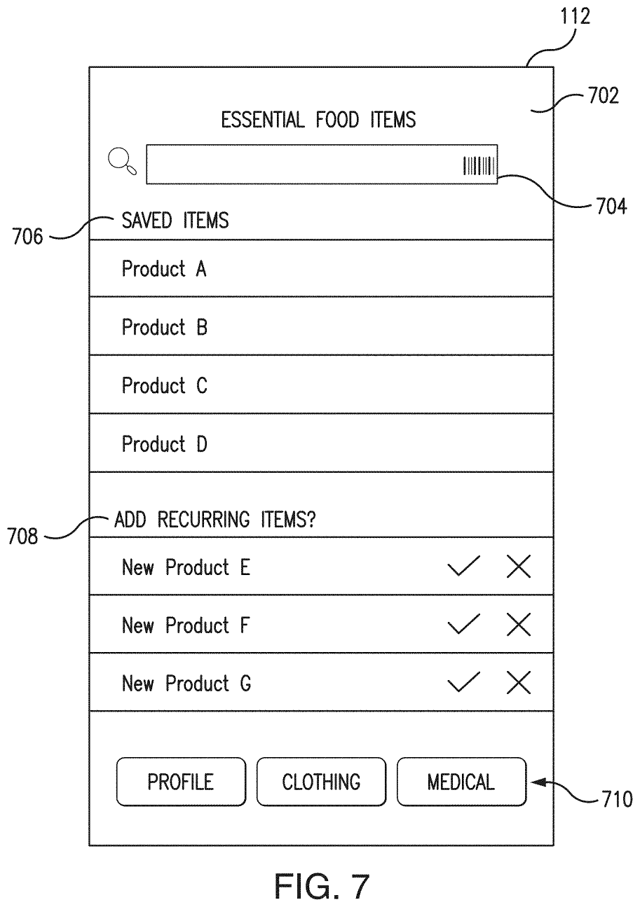

FIG. 7 is an example screenshot of the ENES App 112 showing an “Essential Food Items” screen 702 provided by the item tracker 102. Selection of the “Food” icon on the Profile Details screen 602 enables the user to view and interact with the Essential Food Items screen 702. For example, the user may view their saved food items list 706 and edit the list by selecting individual items on the list. The user is also able to manually add items to the saved food items list 706, for example, by entering items into the search bar 704, for example, via text entry or scanning a barcode displayed on the packaging of the item. In addition, the user can manually add recurring items from the “Add Recurring Items?” section 708. For example, the user can select a checkmark by the recurring item the user wishes to add to the saved food items list 706. Alternatively, the user can select an “X” by the recurring item to remove it from the list, and such item will not be added to the saved food items list 706. In some embodiments, selecting the “X” will provide an indication to the item tracker 102 to no longer track the purchase of this item for adding to the saved food items list 706.

The essential food items screen 702 includes a plurality of icons 710 for the user to interact with to view additional screens of the ENES App 112. The plurality of icons 710 include a “Profile” icon, a “Clothing” icon, and a “Medical” icon. Although three (3) icons 710 are illustrated, it should be understood that there may be any number of icons 710 in various alternate embodiments of the ENES App 112. Selection of the “Profile” icon will return the user to the Profile Details screen 602.

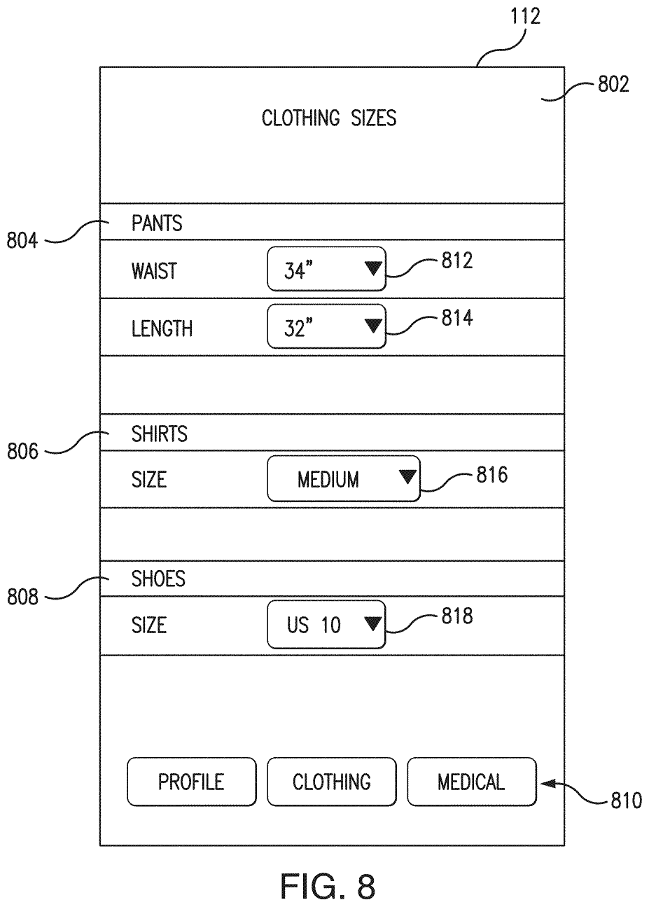

FIG. 8 is an example screenshot of the ENES App 112 showing a “Clothing Sizes” screen 802 provided by the item tracker 102. Selection of the “Clothing” icon on the Profile Details screen 602 or the Essential Food Items screen 702, for example, enables the user to view and interact with the Clothing Sizes screen 802. The Clothing Sizes screen 802 includes three (3) sections, including, for example, a “Pants” section 804, a “Shirts” section 806, and a “Shoes” section 808. In addition, the Clothing Sizes screen 802 includes a plurality of icons 810 for the user to interact with to view additional screens of the ENES App 112. The plurality of icons 810 include a “Profile” icon, a “Food” icon, and a “Medical” icon. Although three (3) icons 810 are illustrated, it should be understood that there may be any number of icons 810 in various alternate embodiments of the ENES App 112. Selection of the “Profile” icon will return the user to the Profile Details screen 602. Selection of the “Food” icon will return the user to the Essential Food Items screen 702.

In the exemplary embodiment, the Pants section 804 includes two (2) measurement entry boxes: one for “Waist” and the other for “Length.” It is noted that any number of measurement entry boxes can be included, which may describe different sizing properties of pants. Selection of the Waist measurement box causes display of a menu of measurement options. The menu of measurement options enables the user to select an appropriate measurement corresponding to their waist size for pants. Selection of the Length measurement box causes display of a menu of measurement options. The menu of measurement options enables the user to select an appropriate measurement corresponding to the length of pants. The user may select a menu option from the menu of measurement options by, for example, tapping, clicking, or hovering over the menu option they wish to select. In the example embodiment, the user has selected 34″ for Waist and 32″ for Length. The ENES App 112 may, in some embodiments, provide the user with a popup command box (not shown) to save the selected menu option.

Similar to the Pants section 804, the Shirts section 806 and the Shoes section 808 include one or more measurement entry boxes. It is noted that any number of measurement entry boxes can be included, which may describe different sizing properties of shirts and shoes, respectively. Selection of the measurement box causes display of a menu of measurement options. The menu of measurement options enables the user to select an appropriate measurement corresponding to their shirt and/or shoe size. The user may select a menu option from the menu of measurement options by, for example, tapping, clicking, or hovering over the menu option they wish to select. In the example embodiment, the user has selected “Medium” for the shirt size and “US 10” for the shoe size. The ENES App 112 may, in some embodiments, provide the user with a popup command box (not shown) to save the selected menu options.

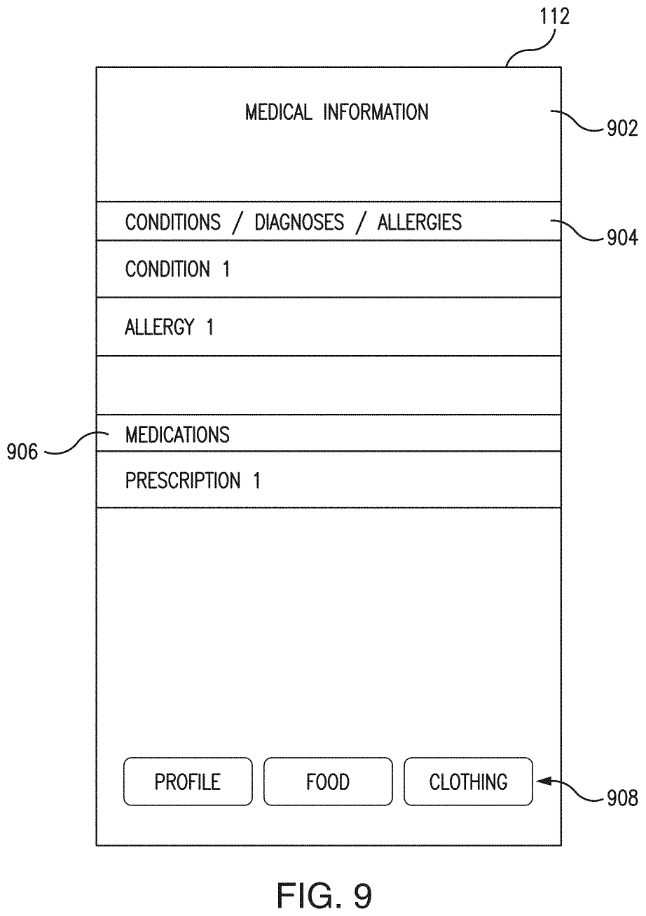

FIG. 9 is an example screenshot of the ENES App 112 showing a “Medical Information” screen 902 provided by the item tracker 102. Selection of the “Medical” icon on the Profile Details screen 602, the Essential Food Items screen 702, or the Clothing Sizes screen 802, for example, enables the user to view and interact with the Medical Information screen 902. The Medical Information screen 902 includes two (32) sections, including, for example, a “Condition/Diagnoses/Allergies” section 904 and a “Medications” section 906. In addition, the Medical Information screen 902 includes a plurality of icons 908 for the user to interact with to view additional screens of the ENES App 112. The plurality of icons 908 include a “Profile” icon, a “Food” icon, and a “Clothing” icon. Although three (3) icons 908 are illustrated, it should be understood that there may be any number of icons 908 in various alternate embodiments of the ENES App 112. Selection of the “Profile” icon will return the user to the Profile Details screen 602; selection of the “Food” icon will return the user to the Essential Food Items screen 702; and selection of the “Clothing” icon will return the user to the Clothing Sizes screen 802.

In the exemplary embodiment, the Condition/Diagnoses/Allergies section 904 allows the user to add his or her known medical conditions and allergies to the ENES App 112 by, for example, pressing or tapping in the provided section and entering the information using, for example, the input device 308 (shown in FIG. 3) of the computing device 108. In addition, the user can add his or her medication prescriptions and other medications (e.g., over-the-counter medications) to the Medications section 906 in substantially the same manner as their medical conditions and allergies.

FIG. 10 is an example screenshot of the ENES App 112 showing an “Emergency Details” screen 1002 provided by the item tracker 102. Selection of the “Details” icon 618 on the Profile Details screen 602, for example, enables the user to view and interact with the Emergency Details screen 1002. The Emergency Details screen 1002 includes a map that shows the area surrounding the user's address and/or known location of their user computing device 108 that is designated as a disaster area and/or is experiencing a catastrophic event.

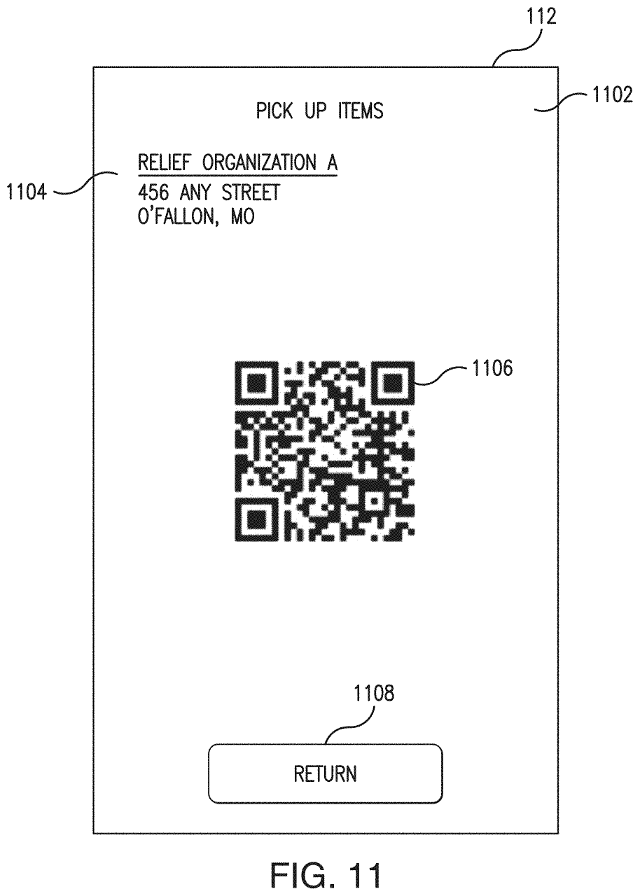

In addition, the Emergency Details screen 1002 includes a “Register for Assistance” icon 1006, a “Donate to Relief Effort” icon 1008, and a plurality of icons 1010 for the user to interact with to view additional screens of the ENES App 112. The plurality of icons 1010 include a “Profile” icon, a “Send List” icon, and a “Pick Up” icon. Although three (3) icons 1010 are illustrated, it should be understood that there may be any number of icons 1010 in various alternate embodiments of the ENES App 112. Selection of the “Profile” icon will return the user to the Profile Details screen 602; selection of the “Send List” icon will transmit the Saved Items list 706 (shown in FIG. 7) to one or more relief organizations that the user has registered with; and selection of the “Pick Up” icon will direct the user to a “Pick Up Items” screen 1102 (shown in FIG. 11) for retrieving the user's item from one or more of the relief organizations.

The Emergency Details screen 1002 includes a listing 1012 of the nearest relief organization to the user's address and/or known location. In some embodiments, the ENE App 112 may include a map pointer 1014 indicating the location of the nearest relief organization on the map 1004.

Selection of the Register for Assistance icon 1006 causes the item tracker 102 to communicate with one or more of the registered relief organizations to transmit, for example, the user's profile information and/or essential needs data, such as the essential items data 512 (shown in FIG. 5), to facilitate registering the user with the one or more relief organizations. The relief organizations receive the user's profile data and can automatically register the user with the respective service. In addition, the relief organizations are configured to receive the essential needs data to facilitate providing a personalized sustainability package to the user to help the user during their time of need. In certain embodiments, the relief organizations may be configured to continue to receive the essential needs data, for example, on a periodic basis, so that they can update the data already received for the user.

In the exemplary embodiment, if the user chooses, he or she may select the Donate to Relief Effort icon 1008 to donate money to the relief organizations. For example, selection of the Donate to Relief Effort icon 1008 causes the item tracker 102 to communicate with one or more of the registered relief organizations to perform a financial transaction, for example, via a digital wallet on the user computing device 108. The transaction is performed, for example, via the payment network 212 (shown in FIG. 2).

FIG. 11 is an example screenshot of the ENES App 112 showing a “Pick Up Items” screen 1102 provided by the item tracker 102. Selection of the Pick Up icon on the Emergency Details screen 1002, for example, enables the user to view and interact with the Pick Up Items screen 1102. The Pick Up Items screen 1102 includes a name of the relief organization 1104 that the user is picking his or items up from, a machine-readable code 1106 (or other identifier) that the user can use to identify himself or herself and the items being picked up, and a “Return” icon 1108, which returns the user to the Profile Details screen 602.

In one embodiment, the machine-readable code 1106 is a QR code. A QR code is a two-dimensional barcode or matrix barcode that is defined by the international standard ISO/IEC 18004:2015. A QR code includes three distinctive marks at the corners of the QR code image and one or more smaller marks proximate the fourth corner to normalize the image for size, orientation, and angle of viewing. In addition, dispersed within the four corners of the QR code are a plurality of small dots that can be converted to binary numbers and validated with an error-correcting algorithm. The binary numbers include data that is encoded within the QR code. In one suitable embodiment, the data encoded in the QR code includes the user's name and address information and/or device IDs (e.g., a device ID of the user computing device 108). While the machine-readable code 1106 described herein is in reference to a QR code, the disclosure contemplates that any type of machine-readable code may be used that enables the system 100 to function as described herein. For example, the machine-readable code 1106 may include one or more of one dimensional barcode formats, such as a UPC, code 39, EAN 8, or EAN 13, other two dimensional formats such as PDF417 or Datamatrix, other n-dimensional barcode formats, and/or alphanumeric text or symbols or the like.

### Exemplary Computer-Implemented Methods

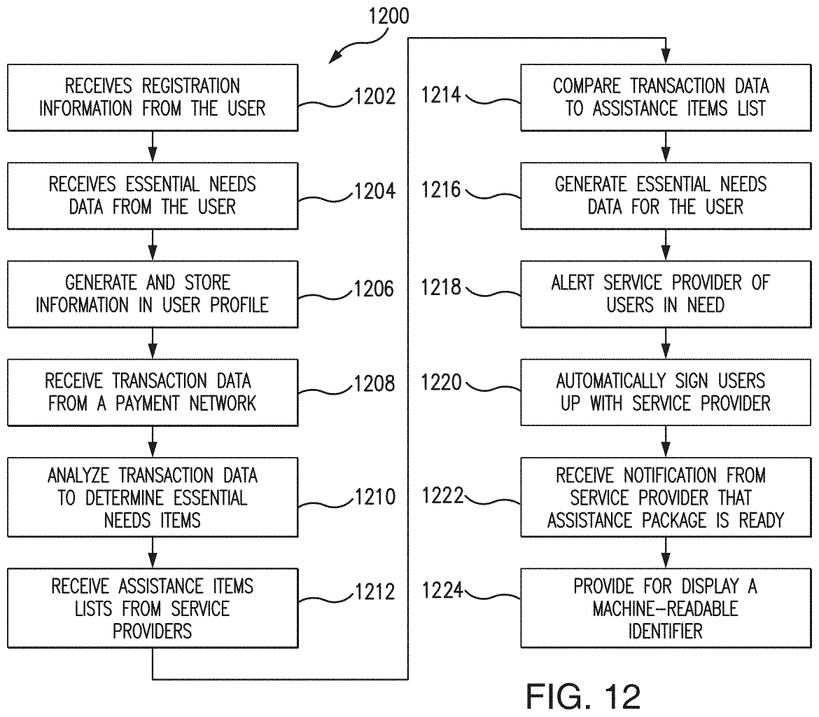

FIG. 12 is a flowchart illustrating an exemplary computer-implemented method 1200 for tracking a user's essential needs items and advising an emergency relief organization about the user's items during a disaster relief effort, in accordance with one embodiment of the present disclosure. The operations described herein may be performed in the order shown in FIG. 12 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 1200 is described below, for ease of reference, as being executed by exemplary devices and components introduced with the embodiments illustrated in FIGS. 1-11. In one embodiment, the computer-implemented method 1200 is implemented by the item tracker 102 (shown in FIG. 1). In the exemplary embodiment, the computer-implemented method 1200 relates to tracking a user's essential needs items and advising an emergency relief organization about the user's items during a disaster relief effort. While operations within the computer-implemented method 1200 are described below regarding the item tracker 102, according to some aspects of the present invention, the computer-implemented method 1200 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, the method 1200 includes registering a user, such as the cardholder 208 (shown in FIG. 2), with the item tracker service. In the example embodiment, after the user opts in to use the item tracker service, the item tracker 102 (shown in FIG. 1) provides a seamless user experience with, for example, Masterpass-enabled applications such as an e-commerce application and the ENES App 112.

At operation 1202, the item tracker receives registration information from the user, such as the user's name and address. In addition, at operation 1204, the item tracker receives essential needs information from the user, such as selected food items, clothing sizes, medical conditions, allergies, and/or medication prescriptions. At operation 1206, the item tracker generates and stores this information in a user profile, such as the user profile 506 (shown in FIG. 5). In some embodiments, the item tracker 102 may be able to pre-populate portions of the user's essential needs data using the line item data for the user's historical purchase data or transaction data, such as the transaction data 508 (shown in FIG. 5), if available. In addition, in some embodiments, the item tracker may provide an option for the user to input their doctor contact information and/or their medical insurance provider information. During user registration, the user may input additional family or household members information into the item tracker 102 for storage with the user profile.

At operation 1208, the method 1200 includes receiving user transaction data (e.g., transaction data 508 (shown in FIG. 5)) from a payment network (e.g., payment network 212, shown in FIG. 1). The transaction data 508 includes, for example, line item data used to identify a user's food-, clothing-, and medicinal-related purchases. In the exemplary embodiment, the line item data includes product-specific-data, such as stock keeping unit (SKU) data. Because the user is registered with the item tracker 102 and the user's payment card or account is linked to the item tracker 102, every time the user uses a digital wallet or swipe/dip at the terminal, the receipt details are captured into the item tracker service. In addition, the item tracker 102 may receive line item data from any payment gateways through which the payment may be routed, for example, automatically and/or on a periodic basis, which may be determined by the user. The payment gateways may have an alternative product/goods identifier other than SKU data. Alternatively or in addition, the item tracker 102 can receive line item data directly from the user computing device 108, such as by, for example, the user scanning a machine-readable code, QR code, barcode, etc. attached to the item he or she is purchasing or wishes to add to the essential needs items list.

At operation 1210, the item tracker 102 analyzes the user's transaction data to determine food, beverage, clothing, and/or medicine to add to the user's essential needs data. The analysis may be commenced, for example, after each transaction, at a predetermined period, upon manual triggering by the user, and the like. In some embodiments, the user can review the essential needs data and remove any items that the user considers non-essential. As described herein, purchases of specific products can be associated with a purchase frequency (i.e., they may be recurring). The item tracker 102 identifies frequently (e.g., recurring) purchased items and adds the items to a recurring items list. In certain embodiments, the item tracker 102 may maintain a transaction history log in which a predetermined period of transactions are maintained to facilitate identifying new items that may be deemed essential, items that may cease to be deemed essential, etc.

In the exemplary embodiment, at operation 1212, the item tracker 102 receives from one or more third party external databases, such as databases 116 (shown in FIG. 1), assistance item data including, for example, a list of those items that are identified as “need to survive items” and/or a list of items that are available from the third party service providers (e.g., providers 118, shown in FIG. 1).

At operation 1214, the item tracker 102 compares to or cross-references the recurring purchased items with the list of items that are identified as “need to survive items” and/or the list of items that are available from the third party service providers. At operation 1216, the item tracker generates the user's essential needs data by adding the matching items identified during the comparison/cross-reference operation and storing the data in the user profile. Thus, recurring but not essential purchases (e.g., purchases of alcohol) are not added to the user's essential needs data.

Upon the occurrence of a catastrophic event (e.g., a hurricane, storm, earthquake, and the like), at operation 1218, the item tracker 102 presents an alert notification to one or more of the service providers 118 indicating that one or more users need emergency assistance. The alert notification may include the user profile 506 of a user in need. The user profile includes the user's essential needs data and his or her name and address. At operation 1220, receipt of the user profile triggers an automatic signup process with the service provider to create an account or sign the user up to the provider's service based on the user profile data. The one or more users are identified based on the user profile data and/or the geo-location data of the user's user computing devices 108. If the user resides or is otherwise located in an area affected by the catastrophic event, the alert may be triggered automatically. Alternatively, the user may receive an alert on his user computing devices 108 and manually trigger registration with the service provider.

In some embodiments, a user may be within the affected area, but may not be impacted by the catastrophic event. In such situations, the user may elect not to receive any of the essential items and/or may select to provide a donation to the service providers 118 working in the area. The user can provide a payment directly to a selected service provider from within the ENES App 112 of the item tracker 102 by performing an electronic transaction using the App.

At operation 1222, the item tracker 102 may receive a notification from the service provider 118 indicating that a personalized sustainability or assistance package has been prepared for the user based on the user's essential needs data and the user profile. The notification can include, for example, and without limitation, an identifier that can be displayed on the user computing device 108 when the user retrieves the personalized sustainability package from the service provider. At operation 1224, when the user picks up the personalized sustainability package, the item tracker 102 provides for display via the ENES App 112, the identifier, such as the machine-readable code 1106 (shown in FIG. 11). Alternatively, if the catastrophic event prevents contact with the user, the service provider 118 may be notified and may elect to deliver the personalized sustainability package or otherwise check in on the user.

ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. An item tracker computing device including a processor coupled in communication with a memory, wherein said processor is programmed to:
receive transaction data from a payment network, the transaction data being associated with a user;
receive assistance items data from a service provider;
process the transaction data and the assistance items data to generate essential needs data for the user;
store the essential needs data in a user profile;
retrieve geo-location data of a user computing device associated with the user, the geo-location data corresponding to a location of the user computing device;
based upon the geo-location corresponding with a location of a catastrophic event, transmit the user profile to the service provider;
provide a service to automatically register the user with the service provider; and
generate a user interface for the user computing device to display an identifier, the identifier comprising a machine-readable code.

2. The item tracker computing device in accordance with claim 1,
said processor is further programmed to:
receive user registration information from the user computing device;
receive user essential needs information from the user computing device; and
process the user registration information, the user essential needs information, the transaction data, and the assistance items data to determine the essential needs data for the user.

3. The item tracker computing device in accordance with claim 2,
the user registration information including at least one of a name and an address of the user of the item tracker computing device.

4. The item tracker computing device in accordance with claim 2,
the user essential needs information including at least one of a clothing size, a medical condition, an allergy indication, and a medication prescription.

5. The item tracker computing device in accordance with claim 2,
said processor is further programmed to:
generate the user profile; and
store the user registration information and the user essential needs information in the user profile.

6. The item tracker computing device in accordance with claim 1,
said processor is further programmed to:
process the transaction data to identify recurring purchased items; and
add the recurring purchased items to a recurring items list.

7. The item tracker computing device in accordance with claim 6,
said processor is further programmed to:
compare the recurring items list to the assistance items data; and
identify items on the recurring items list that match with items in the assistance items data,
wherein generating the essential needs data comprises adding the matching items to the essential needs data and storing the essential needs data in the user profile.

8. The item tracker computing device in accordance with claim 1,
the operation of transmitting the user profile to the service provider further comprising presenting an alert notification to the service provider that one or more users need emergency assistance.

9. The item tracker computing device in accordance with claim 8,
said processor is further programmed to receive a notification from the service provider indicating that a personalized assistance package, based on the essential needs data and the user profile, is ready for pick up by the user, the notification including the identifier for display on the user computing device when the user retrieves the personalized assistance package from the service provider.

10. (canceled)

11. A computer-implemented method for tracking essential needs items of a user and advising a service provider about the essential needs items during a disaster relief effort using an item tracker computing device including a processor coupled in communication with a memory, said method comprising:
receiving transaction data from a payment network, the transaction data being associated with the user;
receiving assistance items data from the service provider;
processing the transaction data and the assistance items data to generate essential needs data for the user;
storing the essential needs data in a user profile;
retrieving geo-location data of a user computing device associated with the user, the geo-location data corresponding to a location of the user computing device;
based upon the geo-location corresponding with a location of a catastrophic event, transmitting the user profile to the service provider;
providing a service to automatically register the user with the service provider; and
generating a user interface for the user computing device to display an identifier, the identifier comprising a machine-readable code.

12. The computer-implemented method in accordance with claim 11, further comprising:
receiving user registration information from the user computing device;
receiving user essential needs information from the user computing device; and
processing the user registration information, the user essential needs information, the transaction data, and the assistance items data to determine the essential needs data for the user.

13. The computer-implemented method in accordance with claim 12,
the user registration information including at least one of a name and an address of the user of the item tracker computing device.

14. The computer-implemented method in accordance with claim 12,
the user essential needs information including at least one of a clothing size, a medical condition, an allergy indication, and a medication prescription.

15. The computer-implemented method in accordance with claim 12, further comprising:
generating the user profile; and
storing the user registration information and the user essential needs information in the user profile.

16. The computer-implemented method in accordance with claim 11, further comprising:
processing the transaction data to identify recurring purchased items; and
adding the recurring purchased items to a recurring items list.

17. The computer-implemented method in accordance with claim 16, further comprising:
comparing the recurring items list to the assistance items data; and
identifying items on the recurring items list that match with items in the assistance items data,
wherein generating the essential needs data comprises adding the matching items to the essential needs data and storing the essential needs data in the user profile.

18. The computer-implemented method in accordance with claim 11,
the operation of transmitting the user profile to the service provider further comprising presenting an alert notification to the service provider that one or more users need emergency assistance.

19. The computer-implemented method in accordance with claim 18, further comprising receiving a notification from the service provider indicating that a personalized assistance package, based on the essential needs data and the user profile, is ready for pick up by the user, the notification including the identifier for display on the user computing device when the user retrieves the personalized assistance package from the service provider.

20. (canceled)
